(19) United States
(12) Patent Application Publication
(10) Pub. No.: US 2009/0291279 A1
(43) Pub. Date: Nov. 26, 2009

(54) FLAT BONDING MEANS, SUCH AS ADHESIVE TAPE, ADHESIVE FILM OR ADHESIVE EDGE, ESPECIALLY FOR USE IN CONSTRUCTION

(75) Inventors: Joern SCHROEER, Herdecke (DE); Heinz Peter RAIDT, Dortmund (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: Ewald Doerken AG, Herdecke (DE)

(21) Appl. No.: 12/468,959

(22) Filed: May 20, 2009

(30) Foreign Application Priority Data
May 23, 2008 (DE) 10 2008 024 804.5

(51) Int. Cl. B32B 7/02; B32B 5/16

(52) U.S. Cl. 428/214; 428/343; 428/332; 428/323

(57) ABSTRACT

A flat bonding structure (1), such as adhesive tape, adhesive film or adhesive edge, especially for use in construction, with at least one bonding region (2) which has at least one adhesive. In order to create a bonding structure (1) which has good temperature stability, good long-term adhesive power, and high initial adherence, the bonding region (2) has at least one first component region (4) with a first adhesive (5) and at least one second component region (6) with a second adhesive (7) and that the first adhesive (5) and the second adhesive (7) have different adhesive properties.

### BACKGROUND OF THE INVENTION

1. Field of Invention

The invention relates to flat bonding means, such as adhesive tape, adhesive film or adhesive edge, especially for use in construction, with at least one bonding region which has at least one adhesive.

2. Description of Related Art

Flat bonding means, such as adhesive tapes, adhesive films or adhesive edges, must often cover a wide application. Thus the partners to be bonded vary depending on:
the chemical nature, especially the surface tension,
surface roughness,
degree of fouling,
surface hardness,
flexibility,
extensibility and
degree of moisture.

Furthermore, different ambient conditions can occur. They are especially temperature, (atmospheric) humidity, and contaminants. Thus, for example, only some of the necessary bonding is done in interiors, for example, workshops, i.e., in a defined environment. Most bonding takes place in the open and often under climatically unfavorable conditions.

Especially in construction, the bonding of construction materials is a major challenge because it is performed under the most varied conditions and with the most varied bonding partners. Often, for example, adhesive tapes with so-called contact adhesives are used. They are used for airtight or watertight bonding of construction films inside and outside or for connection of building components (for example, windows) to the bearing structure and for airtight connection of entire building components in prefabricated home construction. Furthermore, adhesive films are used, for example, in sealing strips which are coated on one or both sides with adhesive over substantially the entire surface.

Important quality criteria for bonding means of the type under consideration are the following:
initial adherence,
temperature stability under loads and
long-term adhesive power.

Adhesive surfaces of the type under consideration often do not cumulatively meet these requirements. It is fundamentally possible to modify the adhesive of a bonding means in order to better match its properties for example, to certain temperature ranges of application. However, it is only possible to shift the properties altogether in the direction of better adhesive properties either at higher or at lower temperatures. Improvements on the one hand always result in deterioration on the other hand.

### SUMMARY OF THE INVENTION

A primary object of this invention is, therefore, to provide a bonding means of the initially named type, especially for use in construction, which offers good results both with respect to the initial adherence and stability, as well as with respect to the long-term adhesive power of the bond, essentially independently of the type of bonding partner or ambient conditions.

The aforementioned object is achieved in accordance with the present invention by a flat bonding means of the initially named type being provided with a bonding region that has at least one first component region with a first adhesive and at least one second component region with a second adhesive and that the first adhesive and the second adhesive have different adhesive properties with respect to adhesive attachment to a base or a bonding partner.

By using at least two different adhesives in component regions which are divided off or separate from one another, it is possible to combine the advantages of both adhesives so that the disadvantages play only a subordinate role. In particular, in the invention such a combination of different adhesives is chosen in which the negative properties of one adhesive are balanced by the positive properties of the other adhesive.

It is especially advantageous if one adhesive is made as a so-called soft adhesive and the other adhesive is made as a so-called hard adhesive. Very soft, highly tacky adhesives have low temperature stability and poor long-term tackiness. Hard adhesives which have high softening temperatures and also high glass transition temperatures yield very good long-term stability when chosen correctly, but only low initial adherence. The combination of an adhesive pair with a soft and a hard adhesive yields a bonding means which has a very large temperature window for use and offers very positive properties both for temperature stability, and both long term and initial adherence.

The combination of a hard and a soft adhesive otherwise offers, in particular, special advantages when the bonding means is to act on rough, especially fibrous surfaces. Soft adhesives penetrate especially well into the intermediate spaces of the fibers and wet a rough surface completely, but have the aforementioned disadvantages of low temperature stability and poor long-term tackiness. The combination of soft/stable and hard also again solves the problem here.

There are a series of criteria which characterize soft adhesives and hard adhesives. They include, for example, the glass transition and softening temperature. The glass transition temperatures can be, in principle, any temperatures. For construction applications, they should be between −80° C. and +100° C., preferably between −60° C. and +60° C., and especially between −40° C. and +20° C. When using different adhesives for the bonding means in accordance with the invention, the differences of the glass transition temperatures between the two adhesives should be between 10° C. and 150° C., preferably between 20° C. and 100° C. and especially between 40° C. and 80° C.

At the softening temperatures it is such that they should be between 40° C. and 200° C., preferably between 60° C. and 150° C. and especially preferably between 75° C. and 130° C. The differences of the softening temperatures when using two different adhesives should be greater than 10° C., preferably greater than 20° C. and especially greater than 30° C. In this connection, it is pointed out that the aforementioned softening temperatures and differences have been determined by way of shear adhesion failure temperature (SAFT) according to ASTM D 4498 at 500 g weight.

The bonding means in accordance with the invention can also be defined by way of peeling forces, the peeling forces having been determined according to AFERA 4001, peel at 180° C., T=23° C., 50 g/m² adhesive on PET, base steel 50 mm wide. The peeling forces are more than 20 N/50 mm, preferably they are greater than 35 N/50 mm and especially preferably roughly 50 N/50 mm. The differences of the peeling forces for different adhesives are greater than 3 N/50 mm, preferably greater than 10 N/50 mm and especially greater than 20 N/50 mm.

Another characteristic of the bonding means in accordance with the invention is the initial adherence. This designates the immediate adhesive force. It was determined here according to the rolling ball method PSTC-6. Here, a steel ball runs down a tilted surface into an adhesive coating. The distance the ball travels until it stops is determined. The ball test is measured in centimeters. Accordingly the initial adherence should be between 1 cm and 150 cm, preferably between 4 cm and 60 cm and especially 8 cm and 20 cm. The differences of the individual adhesives for initial adherence are between 1 cm and greater than 80 cm, preferably between 2 cm and 80 cm, further preferably between 3 cm and 70 cm, and especially between 4 cm and 60 cm. In preferred embodiments where hard and soft adhesives combinations were used in which the soft adhesives had initial adherence values of 4 cm, 4 cm to 8 cm and 2 cm to 6 cm, while the hard adhesives had initial adherence values of 40 cm, 60 cm, and greater than 80 cm. Combinations of all the aforementioned soft adhesives with all the aforementioned hard adhesives have been tested. In in this connection, it has been shown that the soft adhesives had good properties in the cool range or at low temperatures. Conversely, high shearing strength and also peeling strength were achieved at high temperatures for the hard adhesives.

Another characteristic of the bonding means in accordance with the invention is the surface tension of the adhesive which should be between 20 mN/m and 75 mN/m. For two different adhesives the differences of the surface tensions of the two adhesives should be greater than 2 mN/m, preferably greater than 5 mN/m, furthermore preferably greater than 10 mN/m and especially greater than 15 mN/m. Combining two or more adhesives with very different affinity to different surface tensions allows a very versatile bonding surface to be prepared.

In order to be able to ensure relatively reliable bonding to all bonding partners or bases, it has been established that the surface weight of the adhesive or the adhesive coating of the bonding region should be at least 0.5 g/m². Preferably, the surface weight is between 2 g/m² and 2000 g/m², furthermore preferably between 5 g/m² and 500 g/m² and especially between 50 g/m² and 300 g/m².

The application thickness of the adhesive or adhesive coating should be at least 0.5 μm. Preferably, the application thickness is between 2 μm and 2 mm, further preferably between 5 μm and 500 μm and especially between 50 μm and 300 μm.

It is especially advantageous when there are differences in height or thickness between the two adhesives. They should be at least 0.5 μm. Preferably, these differences are between 5 μm and 500 μm, furthermore preferably between 10 and 100 μm and especially between 20 μm and 50 μm. Protrusion of one adhesive relative to the other can also be achieved in that one adhesive, at least in regions, is applied to the other adhesive, therefore projects above it or extends beyond it. In this connection, it is especially favorable if, in particular, the softer adhesive projects beyond the harder adhesive, since this adhesive can then conform especially well to the rough surface of the base/bonding partner. Especially for fibrous surfaces, can the soft adhesive then penetrate into the spaces between the fibers. The projection of one adhesive then causes the compressive force to act especially only on this part of the bonding surface and to be concentrated there.

When using two adhesives, the proportion of each adhesive should be between 1% and 99% of the proportion of the adhesive substance used overall. Preferably the proportion is between 20% and 80% and especially between 40% and 60%. For more than two adhesives, the percentage of each adhesive should be between 1% and 98%, preferably between 10% and 80% and especially between 25% and 50%.

In one preferred embodiment of this invention, the two adhesives, and thus the component regions, are made strip-shaped in a lengthwise, transverse and/or oblique format with the same or different strip widths. The strip widths should be between 0.5 mm and 10 cm, preferably between 1 mm and 5 cm and especially between 2 mm and 1 cm. The strips can have the same or different widths.

However, otherwise, it is also possible for one component region to be made as a matrix and the other component region to be made as domain(s) applied to the matrix or embedded in it. In this configuration, the domains—for round domains—should have a diameter between 0.5 mm and 3 cm, preferably between 1 mm and 1.5 cm and especially between 2 mm and 8 mm. For non-round domains, the corresponding surface dimensions should be provided. As has already been stated above, the domains can be moved into free locations of the matrix or can also be applied to the lower adhesive layer of another adhesive substance. The same of course applies to an execution in strips as well.

Otherwise, it is pointed out that the bonding region and/or the individual component regions need not be coated over the entire surface with the adhesive or adhesives. Individual regions can thus also remain free of adhesive.

Regardless of whether the individual regions are made strip-shaped or as a matrix, it is recommended that at least the laterally outer bordering areas of the bonding region be formed by the hard adhesive. Thus the softer adhesive can be held “captured” within the more stable, harder adhesive execution. For a matrix version of the adhesive arrangement, accordingly the domains should comprise the soft adhesive while the matrix can be made of the hard, stable adhesive. Unwanted running of the adhesive therefore not be feared.

This invention relates fundamentally to any bonding surfaces. However, preferably, adhesive tapes, adhesive films or adhesive edges of webs are made in accordance with the invention. An adhesive tape generally consists of a carrier, optionally, a reinforcement, the adhesive or in accordance with this invention at least two adhesives and a removable, generally silicone-treated cover which is also called a liner. In production, the adhesives can be applied either to the carrier or to the liner. Alternatively, the carrier can also be silicone-treated on the back, so that the adhesive tape can be wound without a liner.

Furthermore, the invention can also be applied to so-called transfer adhesive tapes in which ultimately only the adhesive without a carrier is used.

An adhesive film generally consists of a film in itself which constitutes the carrier, the adhesive layer and a liner.

Films which are to be joined to one another during or after their processing are provided with adhesive edges. The adhesive edge accordingly generally consists of a substrate as the carrier, the edge-side adhesive layer and a liner.

Even if fundamentally all types of adhesives can be used in conjunction with this invention, preferably the use of contact adhesives is suited. Contact adhesives are processed as hot-setting adhesives or as liquid adhesives. Thermosetting adhesives are liquified by raising the temperature and is conveyed with pump pressure into a nozzle, for example, a wide slot nozzle. The cooled film forms the adhesive of the bonding means.

Liquid adhesive is produced by adding solvent or water. The liquid adhesive is applied in pasty or liquid form for example, to a carrier and then dried. Here stable or unstable foams are also possible. The latter facilitate application and mostly collapse into themselves at latest in drying. Physical drying of the applied adhesive coating or adhesive films, for example, in a furnace, can optionally be supplemented or replaced by radiation hardening (IR, UW, beta or gamma radiation).

Raw materials for producing contact adhesives can be contact adhesive substances (PSA) for example, based on synthetic and natural rubber, butyl or styrene rubber, polyurethanes, polyacrylates, polyisobutylene, acrylonitrile copolymers, SBS or SIS block copolymers, and the like. Dispersion adhesives such as acrylate, polyvinylidene, butadiene-styrene, rubber or polyurethane dispersions can also be used. Another class of substances includes hotmelts based on for example, acrylate copolymers, polyamides, saturated polyesters, ethylene-vinyl acetate copolymerizates, silicones or generally olefinic copolymers. But in general inorganic binders and those based on renewable raw materials can also be used. The aforementioned raw materials can be used individually or in mixture.

Otherwise, additives, stabilizers, coloring substances, auxiliary agents and fillers can be used. Stabilizers include antioxidants, UV stabilizers and UV absorbers.

It is advantageous for certain applications to provide interrupted application and/or use of a porous adhesive or of corresponding raw materials for the adhesive. In this way, a vapor-permeable bonding region is formed so that the bonding surface in this respect can be easily used especially in construction. Typical values of the vapor permeability are more than 100 g/m²·24 h. The aforementioned specification relates to the adhesive or the adhesive layer.

Embodiments of the invention are explained in detail below with reference to the accompanying drawings.

### BRIEF DESCRIPTION OF THE DRAWINGS

FIG. 1 is a schematic cross-sectional view of a bonding means in accordance with the invention,

FIG. 2 is a schematic cross-sectional view of a second embodiment of a bonding means in accordance with the invention,

FIG. 3 is a schematic cross-sectional view of a third embodiment of a bonding means in accordance with the invention,

FIGS. 4-11 are top views of different bonding regions of different adhesive surfaces and

FIG. 12 is a schematic representation of a method for producing the bonding means in accordance with the invention.

### DETAILED DESCRIPTION OF THE INVENTION

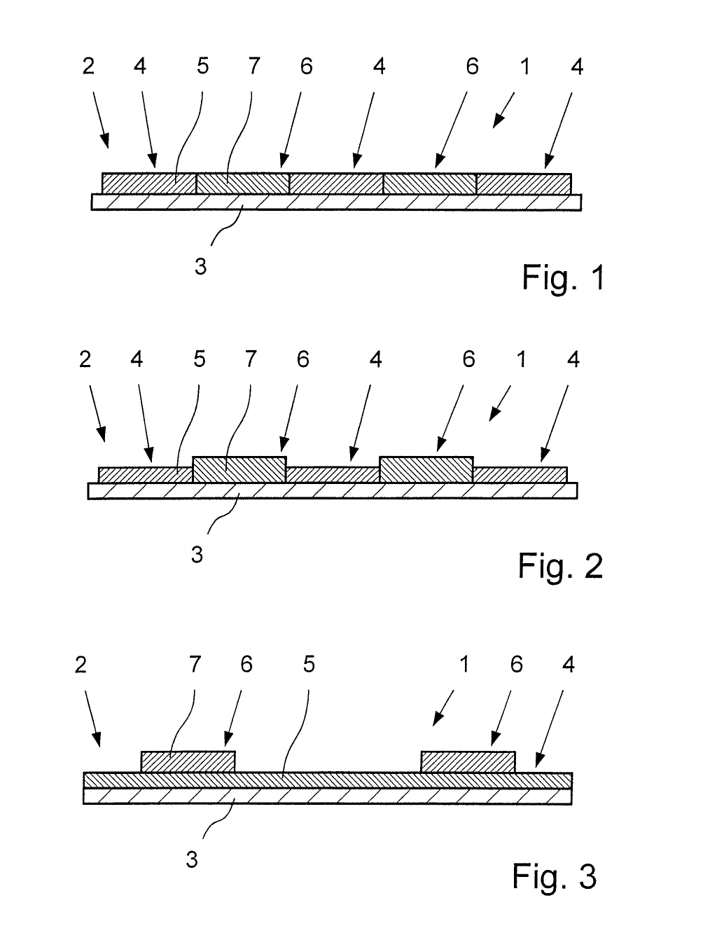

FIGS. 1 to 3 show the basic principle of the flat bonding means 1 in accordance with the invention in different embodiments. In all embodiments, it is such that the bonding means 1 which can be an adhesive tape, an adhesive film or an adhesive edge has a bonding region 2 and a carrier 3. The carrier 3 can fundamentally also be a film or a substrate. In the illustrated embodiments, the bonding region 2 has at least one first component region 4 with a first adhesive 5 and a second component region 6 with a second adhesive 7. The component regions 4, 6 are separated from one another, the adhesives 5, 7 are thus unmixed. It is important that the two adhesives 5, 7 are different and have different adhesive properties with respect to adhesive attachment to a base or a bonding partner.

The embodiments shown in FIGS. 1 to 3 are each a section along the width of the bonding means 1. The length is generally very much greater than the width and can theoretically be infinite. In the embodiment shown in FIG. 1, the bonding region 2 on the carrier 3 is divided into component regions 4, 6 which are located next to one another. Here, there are five component regions 4, 6, the first, third and fifth component region 4 having the first adhesive 5 and the second and fourth region 6 having the second adhesive 7. The layer thickness of all component regions 4, 6 is the same. The width of the individual component regions 4, 6 is also identical. In the illustrated embodiment, especially in the two outer component regions 4, there a hard or stable adhesive 5 with a high glass transition and softening temperature and thus with high temperature stability, which has good long-term stability. The soft adhesive 7 is located in the second and fourth component region 6, and conversely, has a high initial adherence so that the bonding means 1 altogether has good temperature stability, long-term stability and high initial adherence.

The embodiment shown in FIG. 2 corresponds essentially to the one shown in FIG. 1, but with the layer thickness of the second and the fourth component region 6 with the soft adhesive 7 being greater than the layer thickness of the first, third and fifth component region 4.

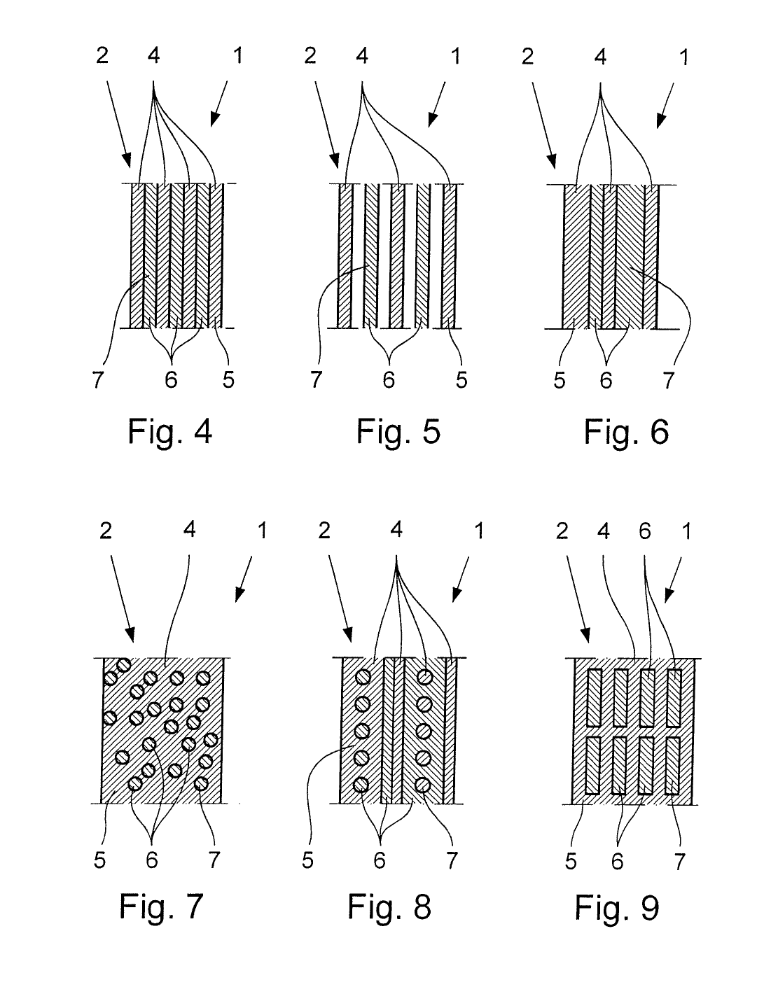

The embodiment as shown in FIG. 3 is based on a similar principle in which the carrier is first coated over its entire surface with one adhesive, here the harder adhesive. This coating forms the component region 4 whose width corresponds to the width of the bonding region 2. As the second component region 6, domains with the second adhesive 7—the soft adhesive—are applied to the first component region 4. Accordingly, the second adhesive 7 of the second component region 6 projects over the first adhesive 5 of the first component region 4. FIGS. 4 to 11 show top views of different bonding regions 2 of bonding

means 1. In the embodiment as shown in FIG. 4, the component regions 4, 6 are strip-shaped with strips of the same width running parallel to one another. Thus, each strip forms a component region 4, 6. The individual strips directly adjoin one another. Here, it goes without saying that the bonding region 2 can be made according to the principles of FIGS. 1 to 3, mixed forms or other principles being fundamentally possible.

In the embodiment shown in FIG. 5, the individual component regions 4, 6 with different adhesives 5, 7 are likewise arranged in alternation, however each component region 4, 6 being spaced apart from the next component region 6, 4, by way of a adhesive-free region, therefore a nonadhesive strip.

In the embodiment as shown in FIG. 6, the bonding region 2 is likewise structured in a strip-shape with alternating component regions 4, 6, the strips however having different widths.

In the embodiment as shown in FIG. 7, the first component region 4 is provided with the first—hard—adhesive 5 as the matrix, while the domains provided in or on the matrix as the second component regions 6 have the second, soft adhesive. The second component region 6 is therefore formed by individual domains.

In the embodiment as shown in FIG. 8, a strip-shaped structure alternate with a matrix/domain structure. The matrix is formed here by a thicker strip of one adhesive 5 with domains 6 of adhesive 7 in the matrix are arranged in a line. It goes without saying that this execution of the domains in a line is not necessary.

In the embodiment shown in FIG. 9, the bonding region 2 is lattice-shaped. Here, the first component region 4 with the first adhesive 5 makes up the lattice structure, while the free spaces of the lattice are the domains of the second component region 6 in which the second adhesive 7 is located.

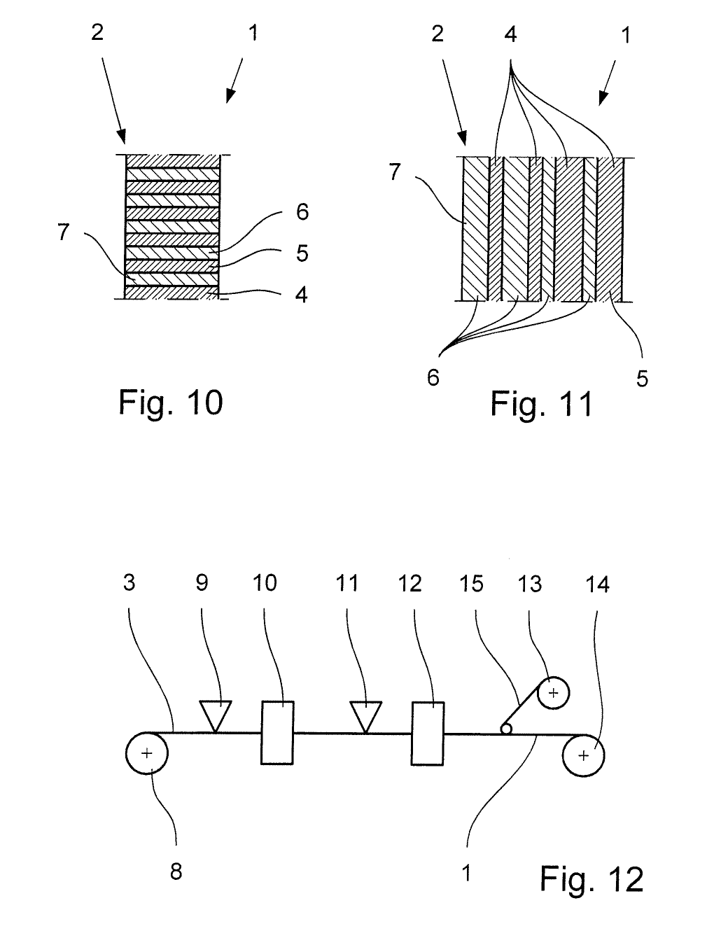

In the embodiment shown in FIG. 10, there are likewise strip-shaped component regions, but, different from the embodiment shown in FIG. 4, the strips do not run in the lengthwise direction, but rather run transversely thereto, one or the other adhesive 5, 7 being provided in alternation.

The embodiment as shown in FIG. 11 corresponds in principle to the embodiment as shown in FIG. 6, but a larger number of wide and narrower strips being provided. Otherwise, in this embodiment, it is such that, on one side of the bonding means 1, predominantly one adhesive type 5 is used, and on the other side, predominantly the other adhesive type 7 is used. Accordingly, on both sides, there are two relatively wide strips with different adhesives 5, 7. In between are narrower strips with the other adhesive 7, 5 in order to achieve the desired positive properties of the bonding means 1.

It is pointed out expressly that the embodiments shown in FIGS. 4 to 11 are only examples of possible embodiments of the bonding region 2 or of the component regions 4, 6. It goes without saying that there are numerous other possible embodiments and configurations. In particular, it goes without saying that the bonding region can have not only a component region with one hard and one soft adhesive, but that there can also be a bonding region with three of more different adhesives. Thus, for example, combinations of a soft with a medium-hard and a very hard adhesive are possible. For certain applications, there can also be a fourth adhesive or even other different adhesives in further gradations. Relative to the initial adherence, for example, there can be a soft adhesive with an initial adherence of 4 cm, a somewhat harder adhesive with an initial adherence of 14 cm, a harder adhesive with an initial adherence of 40 cm and a very hard adhesive with an initial adherence of greater than 60 cm.

Moreover, there can also be two or more adhesives with a surface tension of varied strength so that, ultimately, a very versatile bonding surface results. Thus, for example, for three different adhesives, one adhesive can have a surface tension of 25 mN/m, the second adhesive a surface tension of 35 mN/m and a third adhesive a surface tension of 45 mN/m. It goes without saying that the differences of the surface tensions between two adhesives can also be greater or less than the aforementioned values.

The fundamental production process of the bonding means I in accordance with the invention is explained below using FIG. 12. First, the carrier 3, which can be, as already mentioned, a carrier in itself, a film or a substrate, is unrolled from an unwinder 8. The first adhesive 5 is applied with an application mechanism 9. Rollers, nozzles, a coating table, a doctor blade, imprinting or spraying are possible application mechanisms. Optionally, this is followed by a post-treatment 10 which can be, e.g., drying, hardening and/or cooling. Application of the second adhesive 7 then takes place with the application mechanism 11, optionally followed by post-treatment 12. If other adhesives are used, corresponding additional steps 11, 12 can follow. Steps 11, 12 can be carried out in the same or different way as steps 9, 10. Then, a liner 15 runs off an unwinder 13 and the bonding means 1 in accordance with the invention is rolled onto a winder 14.

It is pointed out that, alternatively, several application mechanisms 9, 11 or several post-treatments 10, 12 can be located directly in succession.

In order to achieve, for example, the desired strip-wise application of adhesive, hot-setting adhesive can be applied instead via a wide slot nozzle or by way of separate individual nozzles as adjacent beads. When liquid adhesive is used, the adhesive can be applied in two steps. In a first pass, for example, the adhesive is applied with a comb-shaped doctor blade only in separate strips with intermediate spaces which remain open. After this adhesive has been dried, the gaps can be filled in during another step.

Another possibility is applying a liquid adhesive from individual nozzles directly next to one another. A multichannel nozzle is also possible. This has the advantage that only one application mechanism is necessary for all adhesives and components 11, 12 are eliminated.

Otherwise it is such that instead of a one-piece liner, also a divided liner can be used. This is always advantageous when the bonding means in accordance with the invention is to be connected, at first, to a first component and subsequently to a second component.

For completed tests the following has been determined:

### 1) Hotmelt Adhesive Tape

Tape 1: An acrylate hotmelt including crosslinking agent (in this connection, Novarad RC 51112 from the company NOVAMELT® was used) was applied in 7 mm wide strips in a thickness of 80 μm to a 55 mm wide corona-pretreated PP carrier using a comb structure nozzle that was temperature-controlled to 130°.

The distance of the total of 5 strips is 3 mm. After cooling, crosslinking took place by irradiation with UV light using a medium pressure mercury emitter with 240 W/cm. The line velocity was 15 m/min. In a second step, using 4 individual nozzles, the corresponding gaps were filled with hotmelt PS 5061 from the company NOVAMELT®. The adhesive application temperature was 160° C., and the application thickness 80 μm.
Tape 2: Production took place analogously to tape 1, only acrylate hotmelt was applied over the entire surface in a 49 mm width and the same thickness.
Tape 3: Production takes place analogously to tape 1, only PS 5061 being applied over the entire surface in a 49 mm width and the same thickness.

The adhesive tapes produced in this way were bonded onto a calandered PP spun nonwoven material. Then, the peeling forces in [N] was checked according to AFERA 4001 (but in other widths, at other bonding temperatures and for other bonding durations).

For tape 1, after one minute, the peeling force was 19 N. For comparison, the adhesive tape coated over the entire surface with an acrylate (tape 2) or PS 5061-coated adhesive tape (tape 3) was likewise bonded with a PP nonwoven. For tape 2, after one minute, the peeling force value was 2 N, while for tape 3 the value was 20 N. After twenty-four hours for tape 1, the value was 20 N, for tape 2 the value was 13 N and for tape 3 the value is 20 N.

Otherwise, ageing was checked for three months at 80° C. For tape 1, the value was 25 N, for tape 2 the value was 26 N and for tape 3 the value was 5 N; this means cohesive failure.

Tapes 1 to 3 were otherwise bonded onto a PP film. After five minutes for tape 1 the value was 50 N, for tape 2 the value was 7 N and for tape 3 the value was 80 N. Bonding on a PP film after three months at 80° C. for tape 1 yielded a value of 74 N, for tape 2 the value was 72 N and for tape 3 the value was 6 N; this means cohesive failure.

### 2) Hotmelt Adhesive Tape on Thermoplastic Polyurethane

Tape 4: Two adhesives in strips were applied alternately next to one another to a 60 mm wide, corona-pretreated 60 g/m² LDPE carrier using a multichannel nozzle which is temperature-controlled to 165° C. Here, it was NOVAMELT® PS 5006 and NOVAMELT® PS 2041 from the company NOVAMELT®. The five strips of PS 5006 were each 5 mm wide and had a thickness of 125 μ. The four strips of PS 2041 were 4 mm wide, had a thickness of 135 μm and were between the strips of PS 5006. The line speed was 55 m/min.
Tape 5: Production took place analogously to tape 4, NOVAMELT® PS 5006 (Tg=10° C.) having been applied over the entire surface to the 60 g/m² LDPE carrier in a 50 mm width and 125 μm thickness.
Tape 6: Production took place analogously to tape 4, NOVAMELT® PS 2041 (Tg=−9° C.) having been applied over the entire surface to the 60 g/m² LDPE carrier in a 50 mm width and 135 μm thickness.

Tapes 4 to 6 were then bonded to a TPU film of DESMOPAN® 385 from Bayer.
a) For bonding in spring at 5° C. for tape 4 there was a peeling force of 40 N, for tape 5, 5 N, and for tape 6 after reaching 50 N the carrier failed.
b) After seven days between 5° C. and 10° C., for tape 4 after reaching 51 N the carrier failed, for tape 5 the value was 25 N, and for tape 6 after reaching 53 N the carrier failed.
c) After seven months, among others, summer with a maximum measured temperature of 69° C., for tape 4 after reaching 48 N, the carrier failed, for tape 5 the carried failed after reaching 50 N and for tape 6 the value was 32 N.

### 3) Adhesive Edge

In a manner analogous to the hotmelt adhesive tape, the two adhesives were applied on the edge side to a 1.5 m wide composite of calandered 120 g/m² PET nonwoven and 60 g/m² TPU coating. The PU coating in the edge region projects 35 mm beyond the PET nonwoven, application of 4+3 strips takes place from the nonwoven side in a total width of 32 mm. Full-surface coatings of individual adhesives take place in a 32 mm width.

Practical bonding on the PU side was done in parallel to the test 2 with a hotmelt adhesive tape, with the following results:
a) For bonding in spring at 5° C., after ten minutes for edge 1, the amount was 34 N, for edge 2 the value was 4 N and for edge 3 the value was 45 N, the composite adhesion failing.
b) After seven days at 5° C. to 10° C., for edge 1 the amount was 45 N, the composite adhesion failing, for edge 2 the amount was 18 N and for edge 3 the amount was 47 N, the composite adhesion failing.
c) After seven months (among others, summer with maximum measured temperature of 69° C.) on edge 1 the value was 48 N, the composite adhesion failing, for edge 2 the amount was 50 N, the composite adhesion failing, and for edge 3 the amount was 24 N.

### 4) Dispersion Adhesive Tape

Tape 7: A one meter-wide PET film with a surface weight of 50 g/m² is coated using a knife over roll doctor blade with a dispersion of carboxylated styrene-butadiene copolymer (LITEX® S 45 C from the company Polymer Latex, Tg=1° C.) and then dried at 80° C. The application weight is 45 g/m² dry. In a second step using a structured roller, an adhesive dispersion based on acrylate (Plextol X 4880 from the company Polymer Latex, Tg=−40° C.) was applied in spots and dried at 70° C. The diameter of the points (domains) was 5 mm, their thickness in the dried state was 15 μm and the surface occupancy was 23%. Subsequently, the liner is supplied and the film cut into 10 cm wide strips.
Tape 8: Production took place as in tape 7, the second step not being carried out. Instead, the liner was directly supplied and cut into 10 cm wide strips.
Tape 9: In a manner analogous to tape 7, only Plextol X 4880 was applied and dried so that a dry bed of 45 g/cm² resulted. Then, the liner was supplied and cut into 10 cm wide strips.

A peel test on a 100 g/m² LDPE film at 23° C. after one minute for tape 7 yielded a value of 65 N, for tape 8 the value was 15 N and for tape 9 the value was 77 N.

After 24 hours at 23° C., a constant load of 10 N was applied and the temperature increased to 50° C. The tape 7 in accordance with the invention and the comparison tape 8 had not yet failed after another 24 hours. Tape 9 failed conversely after twenty three minutes.

What is claimed is:

1. Flat bonding means, especially for use in construction, comprising a carrier on which at least one bonding region is provided, the at least one bonding region having at least one first component region with a first adhesive and at least one second component region with a second adhesive and wherein the first adhesive and the second adhesive have different adhesive properties.

2. Bonding means in accordance with claim 1, wherein one adhesive is made a soft adhesive and the other adhesive is a hard adhesive.

3. Bonding means in accordance with claim 2, wherein the adhesives have glass transition temperatures between −80° C. and +100° C. and wherein the differences of the glass transition temperatures between the two adhesives are between 10° C. and 150° C.

4. Bonding means in accordance with claim 1, wherein the adhesives have softening temperatures between 40° C. and 200° C., and wherein the differences of the softening temperatures between two adhesives are greater than 10° C.

5. Bonding means in accordance with claim 1, wherein the peeling forces of the adhesive are greater than 20 N/50 mm, measured according to AFERA 4001, peel at angle 180°, T=23° C., 50 g/m² adhesive on PET, base steel 50 mm wide, and wherein the differences of the peeling forces between the two adhesives are greater than 3 N/50 mm.

6. Bonding means in accordance with claim 1, wherein initial adherence according to the rolling ball method is between 1 to 150 cm and wherein the difference between the initial adherence of the two adhesives is between 1 to 80 cm.

7. Bonding means in accordance with claim 1, wherein the surface tension of the adhesives is between 20 and 75 mN/m and wherein the difference of the surface tensions between two adhesives is greater than 2 mN/m.

8. Bonding means in accordance with claim 1, wherein the surface weight of surface parts coated with the adhesives is greater than 0.5 g/m².

9. Bonding means in accordance with claim 1, wherein the adhesives have an application thickness of at least 0.5 μm and wherein the difference of application thicknesses between one adhesive and the other adhesive is at least 0.5 μm.

10. Bonding means in accordance with claim 1, wherein the percentage proportion of the two adhesives is between 40 and 60%

11. Bonding means in accordance with claim 1, wherein the component regions are strip-shaped in at least one of a lengthwise, transverse and oblique format.

12. Bonding means in accordance with claim 11, wherein the strip-shaped component regions have a width between 0.5 mm and 10 cm.

13. Bonding means in accordance with claim 1, wherein at least laterally outer bordering areas of the bonding region are formed by the hard adhesive.

14. Bonding means in accordance with claim 1, wherein the component regions are only partially coated with adhesive.

15. Bonding means in accordance with claim 1, wherein the adhesives are contact adhesives.

16. Bonding means in accordance with claim 1, wherein said carrier is in the form of a tape or film.

17. Bonding means in accordance with claim 2, wherein the adhesives have glass transition temperatures between −40° C. and +20° C. and wherein the differences of the glass transition temperatures between the two adhesives are between 40° C. and 80° C.

18. Bonding means in accordance with claim 1, wherein the adhesives have softening temperatures between 75° C. and 130° C. and wherein the differences of the softening temperatures between two adhesives are greater than 30° C.

19. Bonding means in accordance with claim 1, wherein the peeling forces of the adhesive are greater than 50 N/50 mm, measured according to AFERA 4001, peel at angle 180°, T=23° C., 50 g/m² adhesive on PET, base steel 50 mm wide, and wherein the differences of the peeling forces between two adhesives are greater than 20 N/50 mm.

20. Bonding means in accordance with claim 1, wherein initial adherence according to the rolling ball method is between 8 to 20 cm and wherein the difference between the initial adherence of the two adhesives is between 5 to 20 cm.

21. Bonding means in accordance with claim 1, wherein the surface tension of the adhesives is between 20 and 75 mN/m and wherein the difference of the surface tensions between two adhesives is greater than 15 mN/m.

22. Bonding means in accordance with claim 1, wherein the surface weight of surface parts coated with the adhesives is between 50 and 300 g/m².

23. Bonding means in accordance with claim 1, wherein the adhesives have an application thickness between 50 and 300 μm and wherein the difference of application thicknesses between one adhesive and the other adhesive is between 20 and 50 μm.

24. Bonding means in accordance with claim 1, further comprising at least one additional adhesive and wherein the percentage proportion of one of the adhesives is between 25 and 50%.

25. Bonding means in accordance with claim 1, wherein one component region is a matrix and the other component region is made as domains embedded in the matrix.

26. Bonding means in accordance with claim 25, wherein when the domains arranged in the matrix have a diameter between 0.5 mm and 3 cm.
